(19) United States
(12) Patent Application Publication
(10) Pub. No.: US 2023/0242012 A1
(43) Pub. Date: Aug. 3, 2023

(54) SYSTEM FOR ADJUSTING THE POSITION OF AN AUTOMOTIVE SEAT

(71) Applicant: ITALDESIGN-GIUGIARO S.P.A., Torino (IT)

(72) Inventors: Carlo VIGNOLA, Torino (IT); Edoardo DEL GAUDIO, Napoli (IT)

(21) Appl. No.: 17/783,159

(22) PCT Filed: Dec. 9, 2020
(86) PCT No.: PCT/IB2020/061680

§ 371 Date: Jun. 7, 2022

(30) Foreign Application Priority Data
Dec. 9, 2019 (IT) 102019000023343

(51) Int. Cl. B60N 2/02; B60N 2/16; B60N 2/66; B60N 2/22; B60N 2/00

(52) U.S. Cl. CPC B60N 2/0244; B60N 2/002; B60N 2/22; B60N 2/66; B60N 2/1635

(57) ABSTRACT

A system for adjusting a position of an automotive seat has one or more memory units for storing at least one predetermined position of the automotive seat associated with a predefined road type, a road region of a territory, or a predefined driving condition, a positioning system for geographic positioning of a vehicle or devices for monitoring vehicle dynamics, and a control system for controlling actuating devices for moving the automotive seat, or at least a part thereof. The control system is configured to identify a road type, a road region of travel of or a driving condition of the vehicle, to select a predetermined position of the automotive seat according to the road type, the road region of travel or the driving condition, and to control movement of the automotive seat or at least a part thereof to reach the selected position of the automotive seat.

This invention generally relates to the automotive sector and in particular to systems for adjusting the comfort of the passengers of a vehicle.

More specifically, this invention relates to a system for adjusting the position of an automotive seat according to the preamble of claim 1 or claim 4.

The term “position adjustment” generally indicates at least one adjustment and preferably a set of adjustments of the position of different parts of the seat, for example the adjustment of the seat height, the adjustment of its distance from the pedal board, the adjustment of the backrest inclination, and the adjustment of lumbar support devices.

Systems are known for adjusting the position of an automotive seat of a driver or of a passenger, both with manual and automatic movement. Automatic adjustable seats have a control unit for actuating devices of the seat or parts thereof, which stores one or more seat configurations preselected by one or more occupants so that each of them may easily recall the associated seat configuration when boarding the vehicle.

It would be desirable to be able to automatically change the position of the seat also while driving, for example to adapt to the driving dynamics of the vehicle along the current route.

In effect, as the driving dynamics of the vehicle vary according to the type of road driven and the commands given by the driver to the driving systems, such as the propulsion system, the braking system and the steering system, the driving posture and comfort of a passenger vary significantly. For example, driving on highways or on fast-travel road types, characterized by long straightaways, wide-radius curves and infrequent stops, often for long journeys, allows the driver and passenger to have a relaxed posture, for example with the backrest tilted beyond the standard ergonomic angle setting relative to the vertical of the vehicle. Driving in the city or on urban, slow-travel road types, characterized by sudden turns and frequent accelerations and stops, often for short journeys, requires the driver to maintain a posture closer to the driving controls and with the seat higher for greater control of the road surface. Lastly, extra-urban driving on winding paths, for example in mountainous regions, is characterized by frequent bends, accelerations and decelerations and driving on slopes, which requires the driver to have a more upright posture, for example with the seat inclined less than the standard ergonomic angle setting relative to the vertical of the vehicle, raised and close to the driving controls, and for the passenger, greater containment of the body by the backrest of the seat.

This invention has the purpose of providing an improved system for the automatic adjustment of the position of an automotive seat, in particular a system enhanced with the function of adjusting the position of the seat while driving, according to the current or expected driving dynamics of the vehicle.

According to this invention, this object is achieved by a system for adjusting the position of an automotive seat having the features referred to in claim 1 or 4.

Particular embodiments form the subject matter of the dependent claims, the content of which is to be understood as an integral part of this description.

A further subject of the invention is a vehicle comprising a system for adjusting the position of an automotive seat as claimed.

In summary, this invention is based on the principle of adjusting the position of an automotive seat, or a part thereof, automatically and as a function of the geographic position of the vehicle, on the basis of which a current road region of travel of the vehicle and an associated road type is identified, as a result of which a predetermined driving dynamic of the vehicle is envisaged.

Further features and advantages of the invention will be presented in greater detail in the following detailed description of an embodiment thereof, given by way of non-limiting example, with reference to the accompanying drawings, wherein:

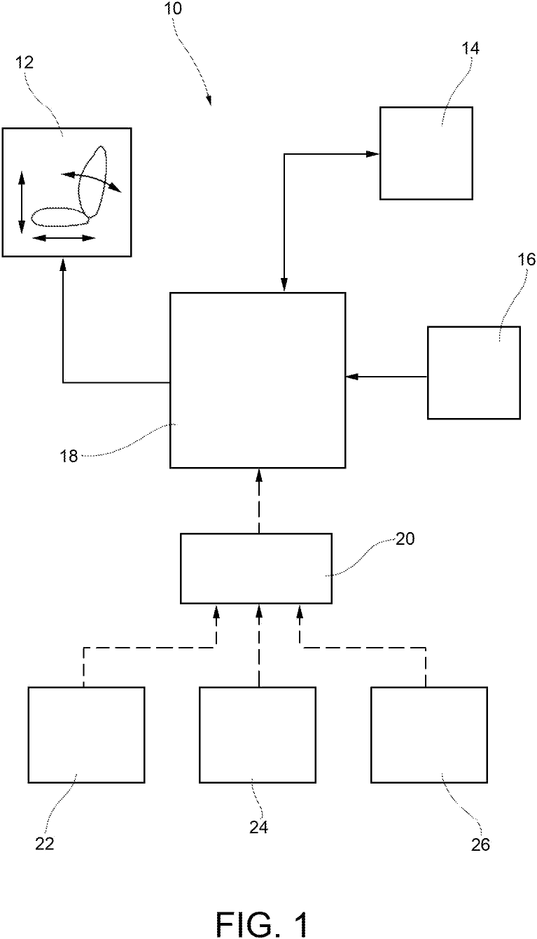

FIG. 1 is a block diagram of a system for adjusting the position of an automotive seat subject of the invention; and

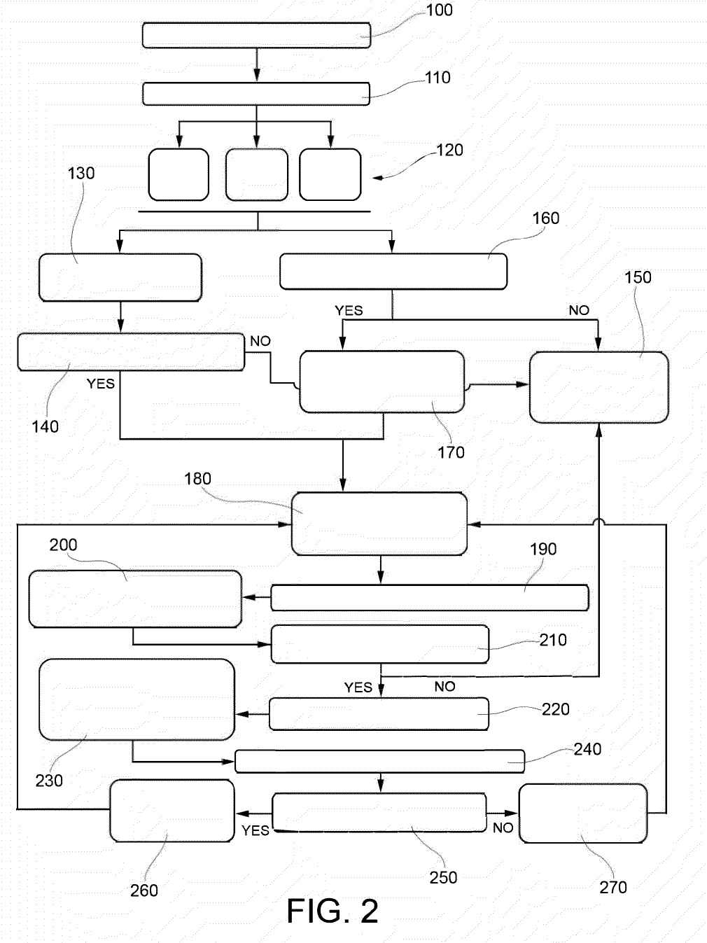

FIG. 2 is a flow diagram of an operating procedure of the system subject of the invention.

With reference to FIG. 1, a system for adjusting the position of at least one automotive seat S is indicated with 10, comprising actuating means for moving the seat or at least a part thereof indicated collectively with 12 and comprising at least one of either a motorized device for the translation of the seat according to a longitudinal direction of moving closer and farther away from the driving controls and possibly according to a raising or lowering direction with respect to the vehicle floor, a motorized device for adjusting a lumbar support, or a motorized device for the rototranslation of the backrest.

The system 10 comprises storage means 14 such as one or more memory units, for example a memory unit associated with each seat, adapted to store at least one predetermined position of the seat associated with a predefined road type or a road region of a territory. For example, the storage means 14 are adapted to store a first seat position associated with an urban road type, a second seat position associated with an extra-urban comfort road type, and a third seat position associated with a mountain road type.

Instead of the association with a predefined road type, represented as data on a road map available to the system, a seat position may be associated with a specific road region of the map, identified by related access road coordinates.

Means for the geographic positioning of the vehicle, such as for example a satellite positioning system, are indicated with 16.

Means for controlling the actuators 12 for the movement of the seat, which are arranged to receive a current geographic position signal of the vehicle from the geographic positioning means 16 and to identify a type of road or a current road region of travel of the vehicle based on the current geographic position thereof, for example by comparison with a stored road map, are indicated with 18.

The control means 18 are also arranged to select a seat position predetermined by the storage means 14 according to the type of road or the current road region of travel of the vehicle.

In an improved embodiment, the control means 18 are also arranged to select in advance a predetermined seat position on the basis of the current geographic position of the vehicle along a set navigation path.

In a further improved embodiment, if no seat position is associated with the current geographic position of the vehicle, the control means are arranged to select a predetermined seat position associated with a road region of travel of the vehicle at a previous time which has the same road type as the current road region of travel of the vehicle.

The control means 18 are arranged to signal to an occupant of the vehicle, and of the seat in particular, whether the driver or a passenger, the seat position selected on the basis of the methods described above, or of other equivalent methods which have not been described here, but are considered within the knowledge of a person skilled in the art. For example, the signaling may be made by an acoustic or visual warning, such as a pictogram or an instruction displayed on the instrument panel or on the console, or both.

Lastly, the control means 18 are arranged to drive the actuating means 12 to control the movement of the seat or of at least a part thereof in such a way as to achieve the selected position. In one embodiment, the driving of the actuating means for controlling the movement of the seat or of at least a part thereof is linked to a consent signal given by the occupant of the vehicle in response to the notification, for example as a voice or tactile command.

Expediently, the system comprises storage means 14 adapted to store a plurality of predetermined seat positions for a plurality of vehicle occupants, each occupant of a vehicle seat being able to be automatically identified.

In an alternative embodiment, also included in the scope of this invention, the storage means 14, in addition to or as an alternative to that which has been described previously, are adapted to store at least one predetermined seat position associated with a predefined driving condition of the vehicle or vehicle dynamics during a predetermined period of time. The system comprises means for monitoring vehicle dynamics 20, arranged to identify one of a plurality of predetermined driving dynamics of the vehicle as a function of signals from a plurality of driving systems, for example a propulsion system 22, a braking system 24, and a steering system 26.

According to this embodiment, the control means 18 are arranged to identify a driving condition of the vehicle which lasts for a predetermined time interval based on the dynamics of the vehicle, select a predetermined seat position from the storage means 14 as a function of said driving condition of the vehicle, and drive the actuating means 12 to control the movement of the seat or at least a part thereof, following the consent given by the occupant, in such a way as to reach the position of the seat selected as a function of the driving condition of the vehicle.

In this case, therefore, the system reacts to the driving behavior of the driver of the vehicle, for example by recognizing a comfortable or sporty ride and adapting the position of the driver’s and passenger’s seats accordingly.

Advantageously, the system subject of the invention, having stored the seat position preferences according to the type of road or driving conditions, will propose these preferences based on the geographic position of the vehicle or the dynamics thereof without further action by the user, i.e. without the user having to manually change the seat position or recall it at will from a preset memory.

The flow chart of FIG. 2 shows a method for adjusting the position of an automotive seat according to the invention.

At step 100 a user, i.e. the driver, and possibly a front seat passenger (but this invention may also be applied to the rear seats or bench seat of a vehicle) access the vehicle, and at step 110 the occupants are identified, automatically or through manual selection by the same occupants of their on-board profile, after registration. At step 120, as a function of the registered and identified occupants, the system selects by reading (or by loading from a remote memory into a temporary quick access memory or cache) a respective library of seat position settings according to the type of road, road regions of a territory, or driving conditions.

Thus, the vehicle user may set a navigation route at step 130, by virtue of which the control means 18 arrange at step 140 a selection of the seat position envisaged at certain points of the route, unless the user disables the automatic seat adjustment function in step 150. Alternatively, if the user of the vehicle does not set a navigation route, the control means 18 arrange at step 160 a selection of the adaptive seat position, based on the identification of the current surrounding road route at step 170, unless the user disables the automatic seat position adjustment function in step 150.

At step 180 the control means 18 identify the geographic coordinates at which the modification of the seat position is envisaged, for example because the type of road changes or because the vehicle enters a road region for which a different seat position has been preset.

When, while driving, the vehicle reaches a predetermined road region or accesses a predetermined road type at step 190, at step 200 the control means 18 identify the position of the seat associated with the aforesaid road region or road type, also as a function of training on the basis of the settings previously adopted by the driver, and possibly by the passenger, in the road region or in road regions previously driven and characterized by the same road type.

Thus, the control means propose to the occupants of the vehicle the seat position selected in step 210. If the user does not accept, the process ends at step 170 with the automatic seat position adjustment function disabled. If the user accepts, in step 220 the control means 18 transmit the configuration data for the seat position selected in step 210 to a control module of the actuating means 12, which controls the actuating means in step 230 to configure the selected seat position, and in step 240 the user may make a change to the seat position.

The control means propose at step 250 the storage of the position in association with the current geographical region and, according to the response from the user by means of the on-board control systems, updates the library of predetermined settings at step 260 or does not update the library and prepares for a subsequent modification at step 270. In both cases, the cycle then returns to step 180 to identify the geographic coordinates of the current road path.

Purely by way of example, such a system recognizes if a vehicle leaves an urban area and enters a highway section, whereby at the highway access gate the system asks the driver if he wants to change the seat position to the comfort driving position. At the end of the highway driving, when the vehicle is heading toward a mountain pass, the system proposes, at a predetermined distance from the beginning of a winding route, to modify the seat position into the position associated with mountain driving.

Advantageously, the driver of the vehicle, as well as the passenger, may adapt the seat position with a simple operation of consent to a modification proposal given by the system on the basis of predetermined preferences, without having to resort to manual or power-assisted adjustment of the seat with a plurality of maneuvers which may be distracting for the driver engaged in driving and therefore would require the vehicle to stop temporarily.

Naturally, without prejudice to the principle of the invention, the embodiments and the details of execution may vary widely with respect to that which has been described and illustrated purely by way of non-limiting example, without thereby departing from the scope of protection of the invention defined by the appended claims.

1. A system for adjusting a position of an automotive seat, comprising actuating devices for moving the automotive seat or at least a part thereof, wherein the system further comprises:
one or more memory units for storing at least one predetermined position of the automotive seat associated with a predefined road type or with a road region of a territory;
a positioning system for geographic positioning of a vehicle; and
a control system for controlling the actuating devices, the control system being configured to:
identify a current road type or road region of travel of the vehicle identified by relative access road coordinates, based on a current geographic position of the vehicle,
select a predetermined position of the automotive seat from the one or more memory units according to the current road type or road region of travel of the vehicle, and
drive the actuating devices to control a movement of the automotive seat or of at least a part thereof to reach said selected position of the automotive seat.

2. The system of claim 1, wherein said control system is configured to select in advance a predetermined position of the automotive seat on the basis of a current geographical position of the vehicle along a set navigation route.

3. The system of claim 1, wherein said control system is configured to select a predetermined position of the automotive seat associated with a past road region of travel of the vehicle which has a same road type as the current road region of travel of the vehicle.

4. A system for adjusting a position of an automotive seat, comprising actuating devices for moving the automotive seat or at least a part thereof, wherein the system further comprises:
one or more memory units for storing at least one predetermined position of the automotive seat associated with a predefined driving condition of the vehicle;
devices for monitoring vehicle dynamics; and
a control system for controlling the actuating devices, the control system being configured to:
identify a driving condition of the vehicle during a predetermined period of time based on the vehicle dynamics,
select a predetermined position of the automotive seat from the one or more memory units according to the identified driving condition of the vehicle, and
drive the actuating devices to control a movement of the automotive seat or of at least a part thereof to reach said selected position of the automotive seat,
wherein the devices for monitoring the vehicle dynamics are configured to identify one of a plurality of predetermined vehicle driving dynamics as a function of signals coming from a plurality of driving systems including a propulsion system a braking system, and a steering system.

5. The system of claim 1, wherein said control system is configured to signal to an occupant of the vehicle said selected position of the automotive seat and to constrain driving of the actuating devices for controlling the movement of the automotive seat or at least a part thereof according to a consent signal given by the occupant of the vehicle.

6. The system of claim 1, wherein said automotive seat is at least one of a driver’s seat, a passenger’s seat.

7. (canceled)

8. The system of claim 1, wherein the movement of the automotive seat includes at least one of a translation of the automotive seat, an adjustment of a lumbar support device, a rototranslation of a backrest.

9. (canceled)

10. (canceled)

11. The system of claim 1, wherein said one or more memory units are configured to store a plurality of predetermined positions of the automotive seat for a plurality of occupants of the vehicle.

12. The system to claim 11, comprising means for automatically identifying an occupant of a seat of the vehicle.

13. A vehicle equipped with at least one automotive seat for an occupant, comprising the system for adjusting a position of the automotive seat of claim 1.

14. The system of claim 4, wherein said control system is configured to signal to an occupant of the vehicle said selected position of the automotive seat and to constrain driving of the actuating devices for controlling the movement of the automotive seat or at least a part thereof according to a consent signal given by the occupant of the vehicle.

15. The system of claim 4, wherein said automotive seat is at least one of a driver’s seat, a passenger’s seat.

16. The system of claim 4, wherein the movement of the automotive seat includes at least one of a translation of the automotive seat, an adjustment of a lumbar support device, a rototranslation of a backrest.

17. The system of claim 4, wherein said one or more memory units are configured to store a plurality of predetermined positions of the automotive seat for a plurality of occupants of the vehicle.

18. The system to claim 17, comprising means for automatically identifying an occupant of a seat of the vehicle.

19. A vehicle equipped with at least one automotive seat for an occupant, comprising the system for adjusting a position of the automotive seat of claim 4.
